(19) United States
(12) Patent Application Publication
(10) Pub. No.: US 2014/0354962 A1
(43) Pub. Date: Dec. 4, 2014

(54) PROTECTION SYSTEM AND PROTECTION METHOD

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 14/288,582

(22) Filed: May 28, 2014

(30) Foreign Application Priority Data
May 29, 2013 (TW) 102118884

(51) Int. Cl. G03B 21/20; G03B 21/14

(52) U.S. Cl. CPC G03B 21/2053; G03B 21/14
USPC 353/85; 353/121

(57) ABSTRACT

A protection method and a protection system against the high-intensity light of a projector include steps of providing a projector which can project, or can be stopped from projection, an projection image onto a screen. A detecting device detects if there is a moving body between the protection system and the screen. A control device controls the protection system to stop the projection of images when a moving body between the protection system and the screen is detected. The control device controls the protection system to return to the normal projection of images when the detecting device detects that the moving body has moved away from the detecting area of the protection system.

### FIELD

The present invention relates to protection systems, and protection method.

### BACKGROUND

Projectors project an optical image by modulating light emitted from a light source, according to image information. The light emitted from the light source, such as a metal halide lamp, a high-pressure mercury lamp, or the like, is usually of high-intensity.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a protection system according to an exemplary embodiment.

FIG. 2 shows the configuration in use of the protection system of FIG. 1.

FIG. 3 shows a flow chart of a protection method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “coupled” is defined, in this disclosure, as meaning connected, whether directly or indirectly through intervening components, and is not necessarily limited to physical connections. The connection can be such that the objects are permanently connected or releasably connected.

The present disclosure is described in relation to a protection system comprising a projection lens, an optical engine, a detecting device, and a control device. The optical engine is coupled with the projection lens, and is configured to emit a light beam to the projection lens, to project images. The detecting device is configured to detect a moving body between the protection system and a screen used for projection, and to generate a trigger signal and send the trigger signal out. The projection distance of the projection lens being inside the range of a detecting area of the detecting device. The control device is connected between the optical engine and the detecting device. the control device is configured to receive the trigger signal sent from the detecting device, and to send a control signal to the optical engine. The control device is further configured to control the optical engine to decrease a light power of the light beam, when the detecting device detecting a moving body, to stop the projection of images.

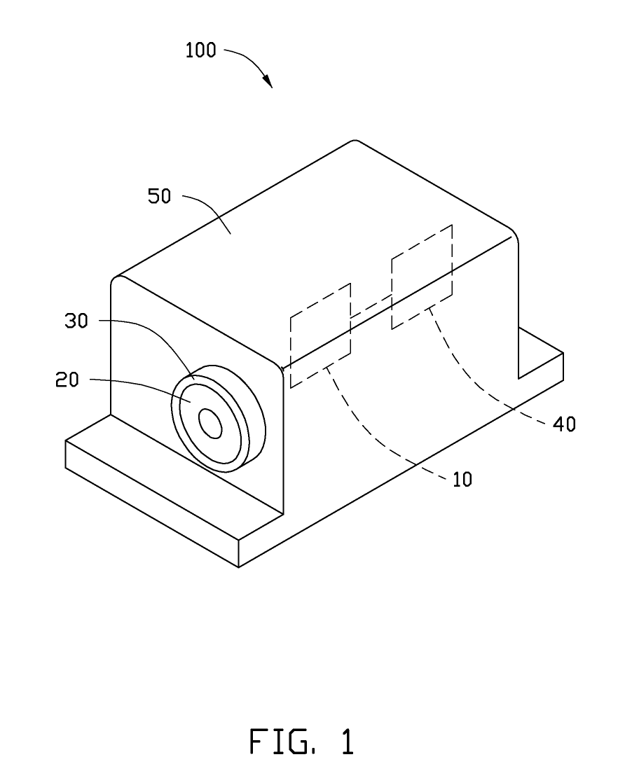

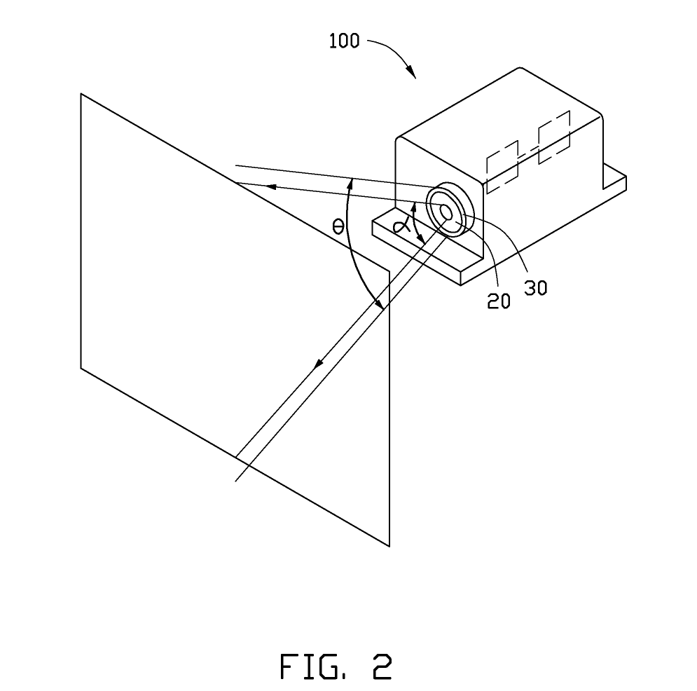

FIGS. 1 and 2 illustrate a protection system 100 against the high-intensity light of a projector according to an exemplary embodiment. The protection system 100 includes an optical engine 10, a projection lens 20, a detecting device 30, a control device 40, and a shell 50.

In this embodiment, the protection system 100 is a miniature laser projector, and the optical engine 10 is configured to emit a laser beam to the projection lens 20, and to project images.

The detecting device 30 is electrically connected to the control device 40. The detecting device 30 is configured to detect a moving body between the protection system 100 and a screen used for projection, and to generate a trigger signal and send the trigger signal to the control device 40. In this embodiment, the detecting device 30 is an infrared detector. The detecting device 30 is arranged around the projection lens 20, and a range of a detecting area of the detecting device 30 is larger than that of a projection distance of the projection lens 20, the projection distance of the projection lens 20 is inside the range of the detecting area of the detecting device 30. In other words, a detecting angle Θ of the detecting device 30 is larger than a projection angle α of the projection lens 20 with respect to a optical axis of the projection lens 20 (shown in FIG. 2).

The control device 40 is connected to the optical engine 10, and, the control device 40 is arranged between the optical engine 10 and the detecting device 30. The control device 40 is configured to receive the trigger signal sent from the detecting device 30, and to send a control signal to the optical engine 10.

The optical engine 10 can be configured to receive the control signal sent from the control device 40. The optical engine 10 can decrease a light power of the laser beam when the control signal is received and accordingly decrease a luminance of the laser beam. After the light power has been decreased, the optical engine 10 can increase the light power of the laser beam to normal value and accordingly increase the luminance of the laser beam, to return the normal projection of images. In this embodiment, the luminance of the laser beam in the decreased state is less than 15 lumens.

In this embodiment, the detecting device 30 can be configured to send a first trigger signal to the control device 40 when a moving body between the protection system 100 and the screen is detected. The control device 40 can be configured to send a first control signal to the optical engine 10 when the first trigger signal is received. The optical engine 10 can decrease the light power to zero when the first control signal is received, to stop the protection system 100 projecting images. The detecting device 30 can also be configured to send a second trigger signal to the control device 40 when the moving body is detected to have moved away from the detecting area of the protection system 100. The control device 40 can also be configured to send a second control signal to the optical engine 10 when the second trigger signal is received. The optical engine 10 can also increase the light power back to a normal value when the second control signal is received, to return the normal projection of images.

The optical engine 10 and the control device 40 are received in the shell 50. The projection lens 20 and the detecting device 50 are mounted on one side of the shell 50, and the projection lens 20 is coupled with the optical engine 10.

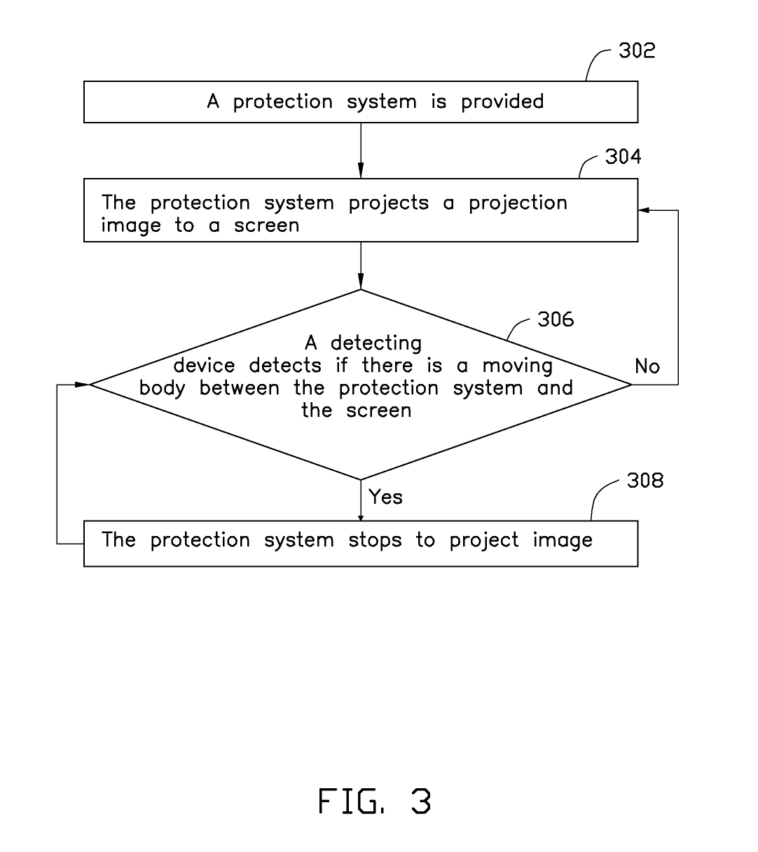

Referring to FIG. 3, a flowchart is presented in accordance with an example embodiment as illustrated. The example protection method 300 against the high-intensity light of a projector is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods, or subroutines which are carried out in the exemplary method 300. Additionally, the illustrated order of blocks is by example only and the order of the blocks can change. The exemplary method 300 can begin at block 302.

At block 302, a protection system 100 is provided. The protection system 100 receives an image signal and projects a projection image to a screen.

At block 304, a detecting device 30 detects any moving body between the protection system 100 and a screen used for projection.

At block 306, a detecting device 30 sends a first trigger signal to a control device 40 when a moving body is detected between the protection system 100 and the screen. A control device 40 sends a first control signal to the optical engine 10 when the first trigger signal is received. An optical engine 10 decreases the light power to zero when the first control signal is received, to stop the projection of images.

At block 308, the detecting device 30 sends a second trigger signal to the control device 40 when it is detected that the moving body has moved away from the detecting area of the protection system 100. The control device 40 sends a second control signal to the optical engine 10 when the second trigger signal is received. The optical engine 10 increases the light power back to a normal value when the second control signal is received, to return the normal projection of images.

The embodiments shown and described above are only examples. Many details are often found in the art such as other features of a protection system and protection method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A protection system, comprising:
a projection lens;
an optical engine coupled with the projection lens, configured to emit a light beam to the projection lens, to project images;
a detecting device configured to detect a moving body between the protection system and a screen used for projection, and to generate a trigger signal and send the trigger signal out, a projection distance of the projection lens being inside the range of a detecting area of the detecting device; and
a control device connected between the optical engine and the detecting device, the control device configured to receive the trigger signal sent from the detecting device, and to send a control signal to the optical engine, the control device further configured to control the optical engine to decrease a light power of the light beam, when the detecting device detecting a moving body, to stop the projection of images.

2. The protection system of claim 1, wherein the control device is further configured to control the optical engine to increase the light power of the light beam, when the detecting device detecting the moving body has moved away, to return to the normal projection of images.

3. The protection system of claim 2, wherein a luminance of the light beam is controlled to decrease according with the light power of the light beam when the detecting device detecting a moving body, the luminance of the light beam in the decreased state is less than 15 lumens.

4. The protection system of claim 3, wherein a luminance of the light beam is controlled to decrease according with the light power of the light beam when the detecting device detecting a moving body, the luminance of the light beam in the decreased state is zero lumen.

5. The protection system of claim 1, wherein the protection system is a miniature laser projector.

6. The protection system of claim 1, wherein the detecting device is an infrared detector.

7. The protection system of claim 1, further comprising a shell, the optical engine and the control device being received in the shell, and the projection lens and the detecting device being mounted on one side of the shell.

8. The protection system of claim 1, wherein a detecting angle Θ of the detecting device is larger than a projection angle α of the projection lens with respect to an optical axis of the projection lens.

9. A protection method, comprising:
providing a protection system, the protection system projecting projection images to a screen;
detecting if there is a moving body between the protection system and the screen; and
stopping the projection of images by decreasing a light power of light beams emitted from the protection system, when a moving body being detected.

10. The method of claim 9, further comprising returning to the normal projection of images by increasing the light power of light beams emitted from the protection system, when the moving body is detected to have moved away from the detecting area of the protection system.

11. A protection system, comprising:
a projection lens;
an optical engine coupled with the projection lens, configured to emit a light beam to the projection lens, to project images;
a detecting device configured to detect a moving body between the detecting device and a screen used for projection, and to generate a trigger signal and send the trigger signal out, a projection distance of the projection lens being inside the range of a detecting area of the detecting device; and
a control device connected between the optical engine and the detecting device, the control device configured to receive the trigger signal sent from the detecting device, and to send a control signal to the optical engine, the control device further configured to control the optical engine to decrease a light power of the light beam, when the detecting device detects a moving body.

12. The protection system of claim 11, wherein the control device is further configured to control the optical engine to increase the light power of the light beam, when the detecting device detecting the moving body has moved away.

13. The protection system of claim 12, wherein a luminance of the light beam is controlled to decrease according with the light power of the light beam when the detecting device detecting a moving body, the luminance of the light beam in the decreased state is less than 15 lumens.

14. The protection system of claim 13, wherein a luminance of the light beam is controlled to decrease according with the light power of the light beam when the detecting device detecting a moving body, the luminance of the light beam in the decreased state is zero lumen.

15. The protection system of claim 11, wherein the protection system is a miniature laser projector.

16. The protection system of claim 11, wherein the detecting device is an infrared detector.

17. The protection system of claim 11, further comprising a shell, the optical engine and the control device being received in the shell, and the projection lens and the detecting device being mounted on one side of the shell.

18. The protection system of claim 11, wherein a detecting angle Θ of the detecting device is larger than a projection angle α of the projection lens with respect to a optical axis of the projection lens.
